(19) United States
(12) Patent Application Publication
(10) Pub. No.: US 2007/0298144 A1
(43) Pub. Date: Dec. 27, 2007

(54) Method for Protecting Bioactive Food Ingredients Using Decoy Ingredients

(75) Inventors: Thierry Saint Denis, Vincennes (FR); Anne Pierson, Bruyeres-Le-Chatel (FR); Olivier Courcon, Briis Sous Forges (FR); Chloe Beal, Paris (FR)

Correspondence Address: FOLEY AND LARDNER LLP;SUITE 500, 3000 K STREET NW, WASHINGTON, DC, 20007, US

(73) Assignee: COMPAGNIE GERVAIS DANONE

(21) Appl. No.: 11/577,620

(22) PCT Filed: Oct. 17, 2005
(86) PCT No.: PCT/EP05/55297

§ 371 Date: Apr. 20, 2007

(30) Foreign Application Priority Data
Oct. 22, 2004 (FR) 0411272

(51) Int. Cl. A23L 1/48

(52) U.S. Cl. 426/61

(57) ABSTRACT

The invention concerns a food product containing one or more living microorganisms and at least one bioactive food ingredient of interest, wherein said bioactive food ingredient(s) of interest are protected: physically, said bioactive food ingredient(s) of interest being preferably encapsulated; and/or by means of at least one decoy food ingredient contained in said food product such that their metabolization by said living microorganisms is reduced. More particularly, the invention concerns a food product containing living microorganisms, bioactive ingredients of interest and decoy ingredients.

The present invention relates to a food product containing one or more living microorganisms and at least one bioactive food ingredient of interest, wherein said living microorganism(s) and said bioactive food ingredient(s) of interest are used in such a way as to reduce the metabolism of said bioactive ingredient(s) by said microorganism(s).

The market for food ingredients, in particular for bioactive or functional peptides (i.e., having a beneficial activity for the consumer either locally in the digestive tract or distally elsewhere in the organism after passing into the circulatory system), has been expanding rapidly over the past few years.

Bioactive peptides are defined sequences of amino acids which are inactive within their protein of origin but which exhibit specific properties once released by enzymatic action. Said peptides are also referred to as functional peptides. Said bioactive peptides are capable of exerting an effect on, among other things, the digestive system, the organism's defenses (for example, an antimicrobial or immunomodulatory effect), the cardiovascular system (notably an antithrombotic or antihypertensive effect) and/or the nervous system (such as a sedative effect or an opioid-type analgesic effect) (see tables 1 and 2 below).

Table 1 below lists the principle functional peptides released by the hydrolysis of proteins from human milk and cow's milk.

TABLE 1

| | Functional | Milk | | |
|---|---|---|---|---|
| Original proteins | peptides* | origin** | | Described activities |
| α-casein | α-casomorphin | | C | opiate activity |
| | α-casein exorphin | | C | opiate activity |
| | casokinin | | C | antihypertensive activity |
| β-casein | β-casomorphin | H | C | activity opiate |
| | casokinin | H | C | immunomodulatory + antihypertensive |
| | CPP | H | C | activity |
| | | | | action on minerals |
| κ-casein | CMP = GMP | | C | modulation of gastrointestinal |
| | casoxin | H | | motility and the release of |
| | casoplatellins | | C | digestive hormones |
| | | | | opiate antagonist |
| | | | | antithrombotic activity |
| α-lactalbumin | fragments 50-53 | H | C | opiate activity |
| β-lactoglobulin | β-lactorphins | | C | opiate activity + antihypertensive |
| | | | | activity |
| lactoferrin | lactoferroxin | | C | opiate antagonist |
| lactotransferrin | | H | | |

*the amino acid sequences are not exactly identical
**H = human milk, C = cow's milk

Table 2 below summarizes the principle physiological activities of the functional peptides found in milk known to date.

TABLE 2

| Activities | Peptides | In vitro | In vivo animal | In vivo man | Ref. |
|---|---|---|---|---|---|
| Effect on digestion | Casein macropeptide | Production of CCK | | | Beucher 1994 |
| | (CMP) | by rat intestinal cells | | | |
| | | | Calf: after ingestion of CMP (210 mg/kg), | Man: after ingestion of | Yvon 1994 |
| | | | inhibition of gastric secretion and reduction | CMP (4 g), reduction in | |
| | | | in plasma CKK concentration | acid secretion | |
| | β-casomorphins | | Rabbit after introduction in the lumen: | | Ben Mansour |
| | | | antisecretory effect on the ileum | | 1988 |
| | | | Dog: after intragastric administration, | | Schusdziarra |
| | | | modulation of postprandial insulinemia; | | 1983 |
| | | | cancellation of this effect by naloxone | | |
| | Natural β- | Several effects on | | | Tomé 1987, |
| | casomorphins and | rabbit ileum | | | 1988-Mahé |
| | certain analogs thereof | | | | 1989 |
| | Non-metabolized β- | Stimulation of intestinal | | | Ben Mansour |
| | casomorphin analogs | absorption of electrolytes | | | 1988 |
| | Casein | | Dog: administration 10 g casein/300 ml | | Defilippi 1995 |
| | | | water by intragastric catheter: inhibition of | | |
| | | | small intestine motility, cancelled by | | |
| | | | naloxone vs. no effect by 10 g of soy protein | | |
| Antimicrobial effect | Lactoferricin | Inhibition of the growth of | | | Tomita 1994- |
| | Casocidin I | pathogenic strains | | | Zucht 1995 |
| | (αS1-casein) 165-203 | | | | |
| | αS₁B-casein fragment | Inhibition of the growth of | Mouse, sheep: effective via IM injection | | Lahov 1996 |
| | (1-23 N terminal) = isracidin | pathogenic strains | against Staphylococcus aureus | | |
| | Human β-casein fragment | | Mouse: protective effect via IV injection | | Migliore-Samour |
| | | | against K. pneumoniae | | 1989 |
| Immunomodulatory effect | Fragments of bovine α- | Proliferation of Con-A-activated | | | Kayser 1996 |
| | lactalbumin and bovine κ-casein | human lymphocytes (PBL) | | | |
| | β-casokinin 10 and synthetic | Proliferation or suppression of | | | Kayser 1996 |
| | β-casomorphin 7 | PBL according to concentration | | | |
| | Human β-casein 54-59 | Stimulation of sheep red blood | | | Parker 1996 |
| | α-lactalbumin 51-53 | cell phagocytosis by mouse | | | |
| | | peritoneal macrophages | | | |
| | Bovine β-casein | Stimulation of mouse peritoneal | No protection in vivo | | Migliore- |
| | Casein 191-193 | macrophages | | | Samour 1988 |
| | Casein 63-68 | | | | |
| | Bovine κ-casein | Inhibition of the proliferation of | | | Otani |
| | Casein macropeptides (106-169) | Peyer's patch B lymphocytes in | | | 1992, |
| | | mouse and rabbit | | | 1995 |
| Antithrombotic effect | Bovine casein glycopeptide | | | CGP isolated in the plasma | Chabance |
| | (bCGP) | | | of newborns after ingestion | 1995 |
| | Hyman casein glycopeptide (hCGP) | | | of formula or breast milk | |
| | Peptide 106-116 of bovine κ- | Inhibition of platelet | | | Jollès 1986 |
| | casein | aggregation | | | |
| | Human lactotransferrin | Inhibition of platelet | | | Raha 1988 |
| | tetrapeptide (39-42) | aggregation | | | |
| | | | Rat and guinea pig with | | Drouet |
| | | | experimental arterial thrombosis: | | 1990 |
| | | | after IV injection, antithrombotic | | |
| | | | activity | | |
| Antihypertensive | Enzymatic hydrolysates of β- | ACE inhibition | | | Mullaly |
| effect | lactoglobulin and α-lactalbumin | | | | 1997 |
| | Synthetic fragments of human | ACE inhibition | Rats receiving angiotensin I: | | Kohmura |
| | β-casein | | after IV injection, arterial | | 1989 |
| | | | pressure returns to initial level | | |
| | Milk peptides fermented by L. helveticus | | Hypertensive rats: ingestion of | | Masuda |
| | and S. cerevisiae | | 10 ml fermented milk/kg body | | 1996 |
| | | | weight, peptides are found in the | | |
| | | | aorta with ACE inhibition | | |
| | Peptides from milk fermented | | Hypertensive rats: after | | Yamamoto 1994 |
| | by L. helveticus | | ingestion, decrease in arterial pressure | | |
| | Peptides from the fermentation | | Hypertensive rats: after | | Nakamura 1995 |
| | of milk by L. helveticus + S. cerevisiae | | ingestion, decrease in arterial | | |
| | Val-Pro-Pro | | pressure | | |
| | (VPP)/II-Pro-Pro (IPP) | | Normal rats: no effect | | |
| | | | | Hypertensive humans (36 | Hata 1996 |
| | | | | subjects): after 8 weeks of | |
| | | | | ingestion of 95 ml/d, | |
| | | | | decrease in arterial pressure | |
| Opiate | β-casomorphins | | Rats: after intracarotid injection, | | Ermisch 1983 |
| effects | | | accumulation of β-casomorphins in | | |
| | | | the region lacking the | | |
| | | | hematoencephalic barrier | | |
| | | | Newborn calves: after their first | | Umbach 1985 |
| | | | meal of cow's milk, β- | | |
| | | | casomorphins in the blood | | |
| | | | Miniature pigs: after ingestion of | | Meisel 1986 |
| | | | bovine casein, β-casomorphin | | |
| | | | isolated from duodenal chyme | | |
| | | | Pups: after ingestion of mother's | | Singh 1989 |
| | | | milk, presence of β-casomorphins | | |
| | | | in the blood | | |
| | | | | Man: after ingestion of cow's | Svedberg 1985 |
| | | | | milk, presence of β- | |
| | | | | casomorphins in the contents | |
| | | | | of the small intestine | |
| | | | | but not in the blood of the adult | Teschemacher 1986 |
| | Synthetic human | Opioid effect on isolated | | | Yoshikawa 1986 |
| | β-casein | guinea pig ileum, | | | |
| | peptides | cancelled by naloxone | | | |
| | Bovine and | Opioid antagonist effects | | | Chiba 1989 |
| | human casoxins | on isolated guinea | | | |
| | (κ-casein) | pig ileum muscle | | | |

Said peptides are generally obtained by the hydrolysis of plant proteins (soy proteins, for example) or animal proteins (caseins or milk serum proteins, for example). Said hydrolysis is generated by enzymatic and/or fermentation methods and generally accompanied by a concentration of the active fraction, a step that is generally needed to provide the related “health benefit.” The production and use of these peptides to provide health benefits have a substantial background in the literature (see Danone World Newsletter No. 17, September 1998).

Among the food vectors likely to accommodate such ingredients, fermented dairy products are in a good position to provide a health benefit due to the presence of ferments and fermentation products (i.e., molecules arising from the transformation, by lactic bacteria, of the substrates present in milk). Up until now, the scientific community has paid the most attention to the properties of ferments. Researchers have recently begun to be interested in fermentation products, among which certain peptides are of particular interest because they are numerous, specific biological messengers. Thus, fermented dairy products appear particularly suitable as vectors for bioactive peptide hydrolysates obtained, for example, from dairy substrates such as caseins or serum proteins.

A major issue arises, however: the microorganisms and, in particular, the lactic bacteria used in the production of fresh dairy products (yogurts, fermented dairy products, milk-based fermented beverages, etc.), are generally capable of consuming peptides to satisfy their nutritional requirements and, more particularly, their nitrogen requirements. Within the framework of the present invention, said issue will be referred to as “peptide metabolism.” Indeed, lactic bacteria possess several degradation and/or transport systems enabling them to metabolize peptides, thus causing said peptides to disappear from the medium:
1. a proteolytic system (cell wall proteases, PRT) which cleaves proteins and large peptides to facilitate the assimilation thereof (“extracellular metabolism system”),
2. systems of transport towards the interior of the cell, one of which is specific for oligopeptides of approximately 10 amino acids in size, the other being adapted to the transport of dipeptides and tripeptides (lactobacilli have an additional tripeptide permease system) (“transport system(s) towards the interior of the cell”), and
3. an intracellular enzyme system capable of degrading peptides into amino acids (including approximately fifteen endopeptidases and exopeptidases) (“intracellular metabolism system”).

Given that the quantity of peptides naturally present in milk is generally too low compared to the requirements of lactic bacteria, it is common to accelerate their growth by providing a peptide supplement. Said peptides are then totally consumed during fermentation.

When all is said and done, because of (i) the nitrogen requirement of lactic bacteria, for which peptides constitute the principle source in milk, (ii) the capacity of said bacteria to consume peptides efficiently, and (iii) the survival of a significant population of lactic bacteria in milk-based fermented products until the use-by date (UBD), the use of ingredients containing functional peptides in fermented dairy products is difficult, even impossible, because said ingredients are generally consumed by the lactic bacteria during fermentation or during storage of the products until the UBD.

In addition, not only is this problem of degradation by the “untimely” metabolism of peptides by bacteria not specific to a given peptide, it is also not specific to a particular ferment (or microorganism, preferably a bacterium, capable of fermenting).

The problem is general in nature and arises regardless of the peptides and microorganisms considered.

As an example, the case of the bioactive αS1 [91-100] peptide can be cited (see European patent EP 0714910; αS1 [91-100] peptide is a peptide with anti-convulsive properties contained in milk protein hydrolysates, marketed in particular by Ingredia: 51-53, Avenue Fernand Lobbedez BP 946 62033 ARPAS Cedex, France, under the name Lactium®). The Applicant thus has observed that the population of living lactic bacteria in the final product continues to metabolize the bioactive peptide during storage of the final product, such that after only 10 days (for fresh products whose UBD is 28 days) approximately 35-55% of the αS1 [91-100] peptide has disappeared, a fact that is completely unacceptable when guaranteeing a “health” effect for the consumer (data not shown).

Since the consumption of the bioactive peptide is caused by the metabolic activity of the ferments, it may be considered useful to reduce this phenomenon by destroying all or part of the microorganisms, for example using a suitable heat treatment (thermization or pasteurization). In this case, it is possible to preserve the αS1 [91-100] peptide (for example, after heating to 75° C. for approximately 1 min).

However, such a solution presents many disadvantages:
the thermization of a fermented dairy mass involves the use of stabilizers added before the heat treatment (pectins, starches, carrageenans, etc.), thus complicating the process and significantly increasing the cost of the formula;
the industrial production line is more complex and requires a more significant specific investment;
the product will no longer benefit from designations related to products containing living ferments (yogurts) and in fact will lose the benefits associated with the consumption of lactic ferments; and
the organoleptic impact, generally negative, is significant.

Consequently, there is a need for a food product containing both living microorganisms, for example a yogurt, and one or more bioactive food ingredients of interest, wherein said bioactive food ingredient(s) of interest would be protected against metabolism by said living microorganisms while preserving the organoleptic qualities of the food product.

By the present invention, the Applicant provides a solution that satisfies the existing need.

Thus, the present invention relates to a food product containing one or more living microorganisms and at least one bioactive food ingredient of interest, wherein said living microorganism(s) and said bioactive food ingredient(s) of interest are used in such a way as to reduce the metabolism of said bioactive ingredient(s) by said living microorganism(s).

Thus, the Applicant has shown that one or more bioactive food ingredient(s) of interest can be effectively protected from metabolism by living microorganisms, if the conditions for using said ingredient(s) with said microorganism(s) are suitable.

Such suitable conditions for use can call upon various means, including:
a) the use of living microorganisms whose capacity to metabolize the bioactive ingredients is reduced; and/or
b) the use of decoy food ingredients which are deliberately “served up” to the living microorganisms; and/or
c) the implementation of physical protection of the bioactive ingredients, notably by the encapsulation of said bioactive ingredients.

It should be noted in this regard that one or more, even all, of these means can be combined advantageously within the same food product.

Thus, one object of the present invention is a food product containing one or more living microorganisms and at least one bioactive food ingredient of interest, wherein said bioactive food ingredient(s) of interest are protected:
physically, said bioactive food ingredient(s) of interest being preferably encapsulated; and/or
by means of at least one decoy food ingredient contained in said food product,
   in such a way that the metabolism of said bioactive food ingredient(s) by said living microorganism(s) is reduced.

As briefly indicated in the preceding general description, according to the present invention “metabolized” or “metabolism” means the transformation or degradation of a substance by one or more living microorganisms, said substance being consumed as a source of nutrients, with the final consequence being the more or less complete disappearance of said substance from the medium.

In the sense of the invention, the metabolism of an ingredient is “reduced” if it is lower than the metabolism of the same ingredient when said ingredient is not protected by at least one of the means provided for within the framework of the present invention.

Advantageously, and ideally, this reduced metabolism tends towards, or even reaches, zero, which leads to little, practically no, or even no, metabolism of said ingredient.

According to a specific embodiment of the present invention, the residual quantity of the bioactive food ingredient(s) of interest in said food product is, three weeks after the preparation thereof, approximately 50-100% compared to the quantity of bioactive food ingredient(s) of interest present in the product immediately following the preparation thereof.

Preferentially, said residual quantity is approximately 80-100%.

According to the present invention, “residual quantity of bioactive food ingredient(s) of interest in said food product” means the percentage of bioactive food ingredient(s) of interest present in said food product when the latter is maintained under suitable storage conditions (for example, approximately 4-10° C. for a fresh product) for three weeks, compared to the starting percentage of bioactive food ingredient(s) of interest present, i.e., immediately after the product is produced.

Preferably, the food product according to the invention contains at least one decoy food ingredient.

According to the present invention, “decoy food ingredient” means a food ingredient (preferably a peptide or a protein, or an analog or derivative thereof, or combinations thereof) capable of acting as a source of nutrients (in particular a source of nitrogen) for living microorganisms, preferentially intended to be metabolized by said microorganisms in such a way as to divert the latter from the bioactive ingredients of interest which, of course, as a priority, are sought to be preserved. Thus, the decoy ingredient represents a source of nutrition for the microorganisms, one which is deliberately sacrificed in order to safeguard as much as possible the bioactive ingredients of interest. The decoy food ingredient acts in this regard as a competitive inhibiter of the transport of the bioactive ingredients of interest.

It should be noted that, in a quite advantageous manner, the presence of decoy ingredients in the food product makes it possible to use any suitable living microorganism for the production of said product, without it being necessary to take into account the capacity of said microorganism to metabolize the bioactive ingredient(s).

According to a specific embodiment of the present invention, the food product contains between approximately 0.001% and 2% by weight of decoy food ingredient(s) compared to the total weight of the final product.

Preferentially, the food product contains between approximately 0.001% and 0.2% by weight of decoy food ingredient(s) compared to the total weight of the final product.

According to a specific embodiment of the present invention, the rate of metabolism of the decoy food ingredient(s) in the food product is, three weeks after the preparation thereof, at least equal to that of the bioactive ingredient(s). This rate of metabolism of the decoy food w 13 ingredient(s) is, preferably, higher than that of the bioactive food ingredient(s) of interest.

According to a specific embodiment of the present invention, said bioactive food ingredient(s) of interest and/or said decoy food ingredient(s) are selected among:
proteins,
peptides,
analogs or derivatives thereof, and
combinations thereof.

Preferentially, the bioactive food ingredient of interest is selected among: αS1 [91-100] peptide (see European patent EP 0714910), C6-α_{S1 [}194-199] peptide (see U.S. Pat. No. 6,514,941), C7-β [177-183] peptide (see U.S. Pat. No. 6,514,941), C12-α_{S1 [}23-34] peptide (see U.S. Pat. No. 6,514,941), casein phosphopeptides (CPP), α-casomorphin, α-casein exorphin, casokinin, β-casomorphin, casein macropeptides (CMP), also known as glycomacropeptides (GMP) or casein glycomacropeptides (CGMP), casoxin, casoplatellins, fragments 50-53, β-lactorphins, lactoferroxin, Val-Pro-Pro peptides (see European patent EP 0583074), Lys-Val-Leu-Pro-Val-Pro-Gln peptides (see application EP 0737690), Tyr-Lys-Val-Pro-Gln-Leu peptides (see application EP 0737690), Tyr-Pro peptides (see application EP 1302207 and patent EP 0821968), Ile-Pro-Pro peptides (see Nakamura et al., 1995, and Japanese patent JP 6197786), fragments, analogs and derivatives thereof, proteins and/or peptides comprised thereof and combinations thereof (for a review, see in particular Danone World Newsletter No. 17, September 1998).

Even more preferably, the bioactive food ingredient of interest is selected among: αS1 [91-100] peptide, fragments, analogs and derivatives thereof, proteins and/or peptides comprised thereof, and combinations thereof.

“Analog” means any modified version of an initial compound, in this case a protein or a peptide, said modified version being natural or synthetic, wherein one or more atoms, such as atoms of carbon, hydrogen or oxygen, or heteroatoms such as nitrogen, sulfur or halogen, have been added to or removed from the structure of the initial compound in such a way as to obtain a new molecular compound.

In the sense of the invention, a “derivative” is any compound that has a resemblance to or a structural motif in common with a reference compound (protein or peptide). Also falling under this definition are compounds that, alone or with others compounds, can be precursors or intermediate products in the synthesis of a reference compound, via one or more chemical reactions, as well as compounds that can be formed from said reference compound, alone or with others compounds, via one or more chemical reactions.

Thus, compounds covered by the definition of “derivatives” above include hydrolysates, in particular tryptic hydrolysates, proteins and/or peptides, hydrolysate fractions, as well as mixtures of hydrolysates and/or hydrolysate fractions.

Moreover, the terms “analog” and “peptide or protein derivative” mentioned above cover, for example, a glycosylated or phosphorylated peptide or protein or one having undergone the addition of a chemical group.

In another embodiment of the present invention, the bioactive food ingredient(s) of interest and/or the decoy food ingredient(s) can be sugars or fatty acids.

Advantageously, said decoy food ingredient(s) are nutritional sources of nitrogen for said living microorganism(s).

Preferentially, said decoy food ingredient(s) are selected among:
Alatal® 821 (containing a whey protein hydrolysate, sold by Fonterra (Europe) GmbH: 80 avenue de la Grande Armée, 75017 Paris, France;
Vitalarmor 950 (Armor Proteins, France);
fragments, analogs or derivatives thereof;
proteins and/or peptides comprised thereof; and
combinations thereof.

According to a specific embodiment of the present invention, said living microorganism(s) have an intact or reduced capacity to metabolize said bioactive food ingredient(s) of interest.

According to the present invention, a “reduced capacity to metabolize” is one in which the quantity of bioactive ingredients of interest metabolized during fermentation (which thus disappears from the medium) is less than or equal to 40% of the initial quantity of ingredients (before fermentation) This is represented mathematically by:
Qᵣ≧0.6Q₀ (1)
in which Qᵣ=residual quantity of bioactive ingredients (present in the medium after fermentation) and Q₀=initial quantity of bioactive ingredients.

The residual quantity of bioactive ingredients (Qᵣ) can be measured by a method using high-performance liquid chromatography (HPLC) coupled with an MS/MS detector. An example of the experimental procedure is presented in the examples below.

For use as living microorganisms, living bacteria, preferably living lactic bacteria, are preferred.

More specifically, living bacteria will be chosen among:
Streptococcus spp., preferably Streptococcus thermophilus;
Lactobacillus spp.;
Lactococcus spp.; and
Bifidobacterium spp.

Preferably, living bacteria will be chosen among:
Streptococcus thermophilus, deposited with the CNCM (Collection Nationale de Cultures de Microorganismes (Pasteur Institute, Paris, France)) on Jan. 24, 2002, number I-2774;
Streptococcus thermophilus, deposited with the CNCM on Oct. 24, 1995, number I-1630;
Streptococcus thermophilus, deposited with the CNCM on May 10, 2004, number I-3211;
Streptococcus thermophilus, deposited with the CNCM on Sep. 16, 2004, number I-3301; and
Streptococcus thermophilus, deposited with the CNCM on Sep. 16, 2004, number I-3302.

More preferably, said living bacteria are S. thermophilus bacteria deposited with the CNCM on May 10, 2004, number I-3211.

Advantageously, the food product contains at least the living bacteria S. thermophilus and Lactobacillus spp.

Preferentially, said living Streptococcus thermophilus bacteria are selected among: Streptococcus thermophilus deposited with the CNCM on Jan. 24, 2002, number I-2774; Streptococcus thermophilus deposited with the CNCM on Oct. 24, 1995, number I-1630; Streptococcus thermophilus deposited with the CNCM on May 10, 2004, number I-3211; Streptococcus thermophilus deposited with the CNCM on Sep. 16, 2004, number I-3301; and Streptococcus thermophilus deposited with the CNCM on Sep. 16, 2004, number I-3302.

The content in living microorganisms of the food product according to the invention may vary and will be chosen by those skilled in the art in the light of their general understanding of the field. In practice, a standard overall content will be sought that is preferably, for example, approximately 10⁷ to 10⁹ bacteria per gram of food product.

Preferentially, the food product according to the present invention is a fermented product.

More preferably, the fermented food product is a dairy or plant product.

According to the present invention, “dairy product” means, in addition to milk, products derived from milk, such as cream, ice cream, butter, cheese and yogurt; secondary products, such as whey and casein; as well as any prepared food containing, as a principle ingredient, milk or components of milk.

“Plant product” means, among other things, products obtained from a plant base such as, for example, fruit juices and vegetable juices, including soy milk, oat milk and rice milk.

In addition, each of the definitions of “dairy product” and “plant product” above covers any product containing a mixture of dairy and plant products, such as a mixture of milk and fruit juice, for example.

The present invention also has as an object a method for preparing a food product such as defined above, wherein one or more decoy food ingredients are added to the mixture constituting said product, preferably after fermentation thereof.

According to one embodiment, one or more living microorganisms and one or more bioactive food ingredients of interest and/or one or more decoy food ingredients are added sequentially to the mixture constituting said food product.

Alternatively, said bioactive food ingredient(s) of interest and/or said living microorganism(s) and/or said decoy food ingredient(s) are added simultaneously to said mixture.

The culture conditions for the microorganisms are dependent upon said microorganisms and are known to those skilled in the art. As an example, it can be specified that the optimal growth temperatures for S. thermophilus generally range between approximately 36° C. and 42° C.; said temperatures range between approximately 42° C. and 46° C. for L. delbrueckii spp. bulgaricus (which is commonly found in yogurts).

As a general rule, fermentation is stopped by rapid cooling when the desired pH is reached, thus slowing down the metabolic activity of the microorganisms.

According to a specific embodiment of the present invention, said bioactive food ingredient(s) of interest and/or said decoy food ingredient(s) are prepared directly in the mixture constituting said food product. This is referred to as “in situ synthesis” of the bioactive ingredient(s) and/or decoy ingredient(s).

In the case of in situ synthesis, it can be equally anticipated that said living microorganism(s) are added to the mixture constituting said food product before, during or after the in situ synthesis of the bioactive ingredient(s) and/or the decoy ingredient(s).

The present invention also has as an object the use of one such food product as described above as a functional food.

“Functional food” means a food product that advantageously affects one or more target functions of the organism, independent of its nutritional effects. Said functional food can thus lead to an improvement in the health and/or well-being and/or a reduction of the risks of the appearance of diseases in a consumer who ingests normal quantities of said product. As examples of activities of a functional food, it is possible to cite in particular anti-cancer activities, immunostimulatory activities, activities promoting bone health, anti-stress activities, opiate activities, anti-hypertension activities, activities improving the bioavailability of calcium and antimicrobial activities (Functional Food Science in Europe, 1998).

Such functional foods can be intended for man and/or for animals.

The present invention also has as an object the use, in a food product containing one or more living microorganisms and at least one bioactive food ingredient of interest, of at least one decoy food ingredient to protect said bioactive food ingredient(s) of interest against metabolism by said living microorganism(s).

The present invention is illustrated by the following figures, which are in no case limiting.

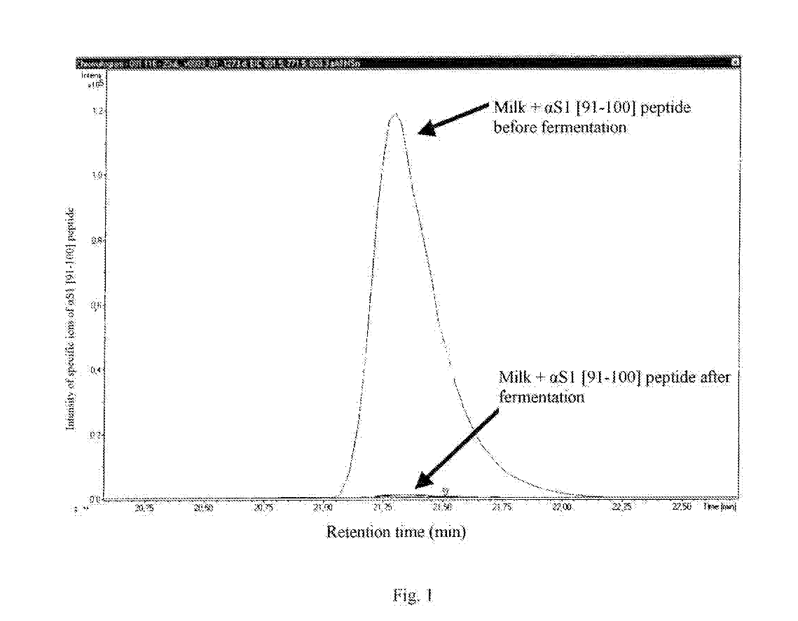

FIG. 1: LC-MS chromatogram illustrating the disappearance of the bioactive αS1 [91-100] peptide included in Lactium® during lactic fermentation. The MS/MS detector is adjusted in such a way as to only detect the ion signal for m/z=634.5 Da (mass of the doubly charged αS1 [91-100] peptide) which exhibits, after fragmentation, daughter ions for m/z=991.5 Da, 771.5 Da and 658.3 Da (fragments characteristic of the αS1 [91-100] peptide).

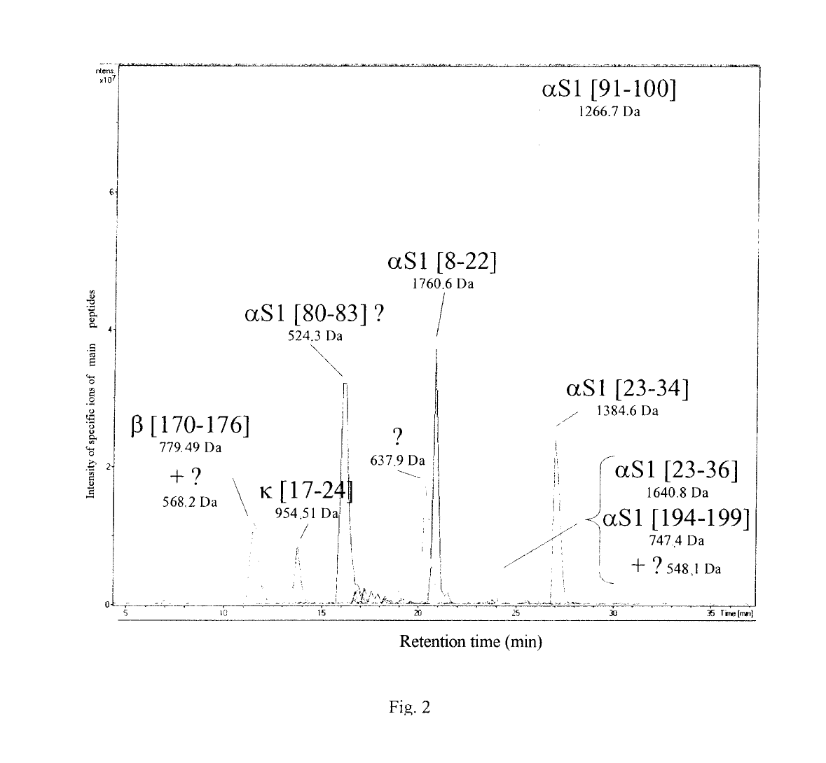

FIG. 2: Identification and quantification of the principle peptides of Lactium® by LC-MS/MS before and after fermentation of the dairy “mix” by a ferment consisting of a mixture of the strains I-2783 (deposited with the CNCM on Jan. 24, 2002), I-2774 (deposited with the CNCM on Jan. 24, 2002), I-2835 (deposited with the CNCM on Apr. 4, 2002) and I-1968 (deposited with the CNCM on Jan. 14, 1998). After fermentation, said peptides are only found in trace amounts and are confounded with the baseline. The question mark symbol (?) means that identification of the sequence was not possible or is uncertain; only the mass of the peptide is then reported.

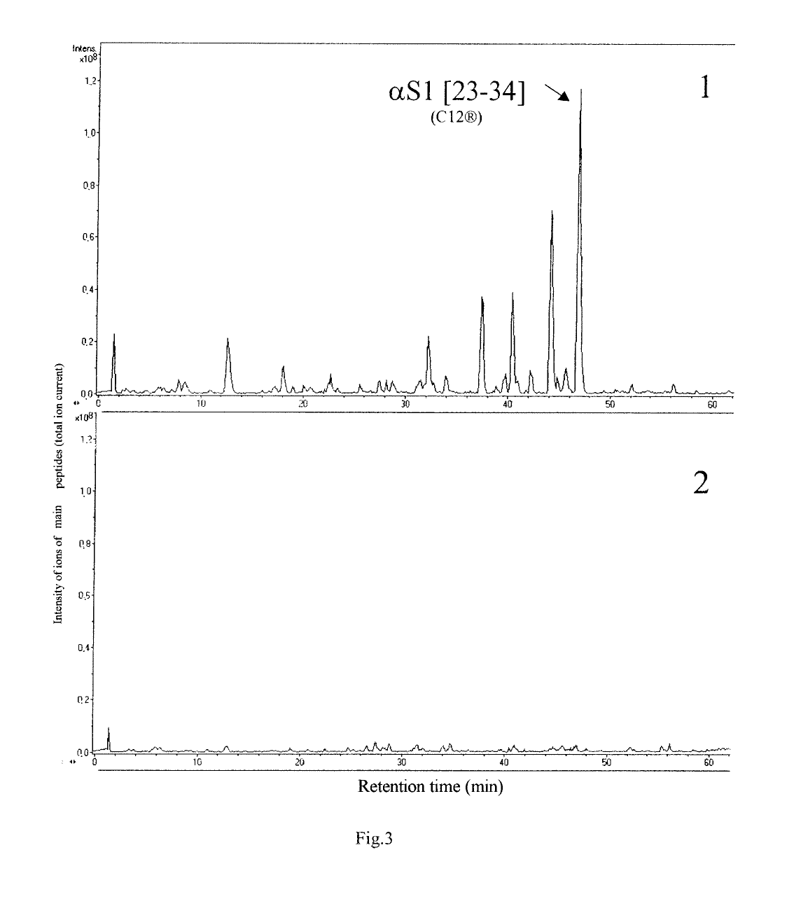

FIG. 3: Compared peptide profiles (LC-MS/MS chromatograms) of a dairy “mix” containing 1.5 g/l of DMV C12® hydrolysate, before (1) and after (2) fermentation up to pH 4.7 by the Hansen YC-380 lactic ferment. Virtually all of the hydrolysate peptides, including the bioactive C12 peptide (αS1 [23-34] fragment), disappeared following metabolism by the ferment strains.

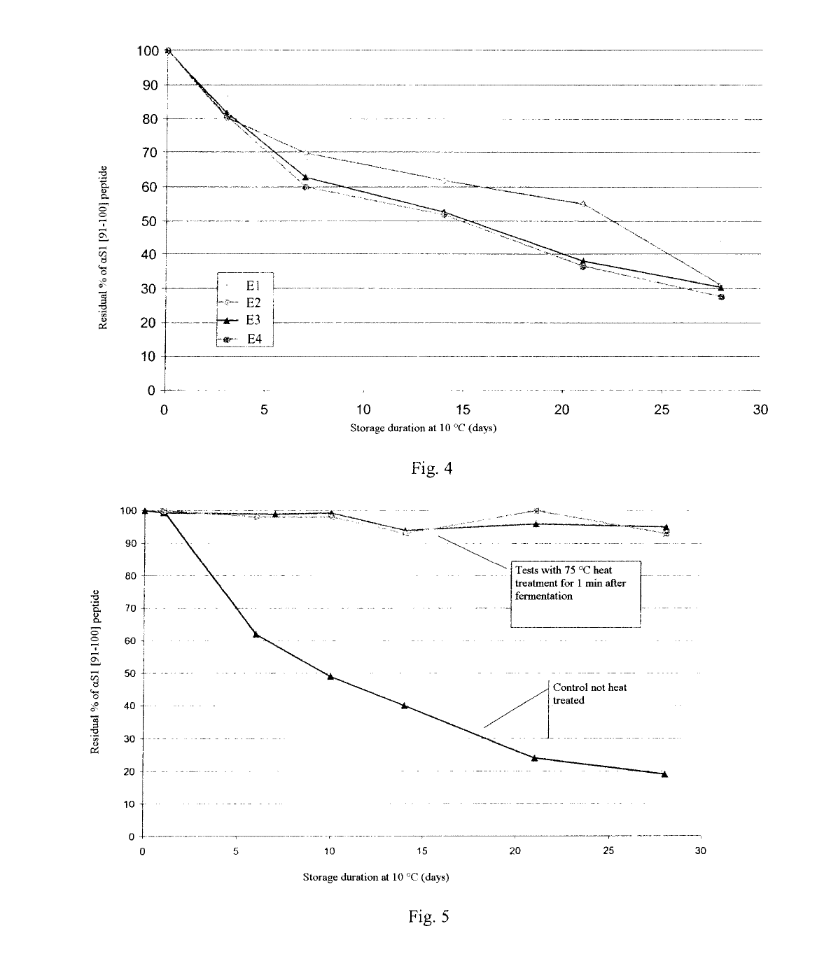

FIG. 4: Curves illustrating the evolution of the residual content in bioactive αS1 [91-100] peptide in a final product comprised of 95% mass fermented by the ferment containing strains I-2783, I-2774, I-2835 and I-1968 and 5% flavored sugar syrup containing the αS1 [91-100] peptide, during storage at 10° C. The experiment was comprised of four independent tests: E1, E2, E3 and E4.

FIG. 5: Curves illustrating the evolution of the residual content in bioactive αS1 [91-100] peptide added after fermentation in a fermented product which was then heat treated at 75° C. for 1 minute and then stored at 10° C. until the use-by date (UBD).

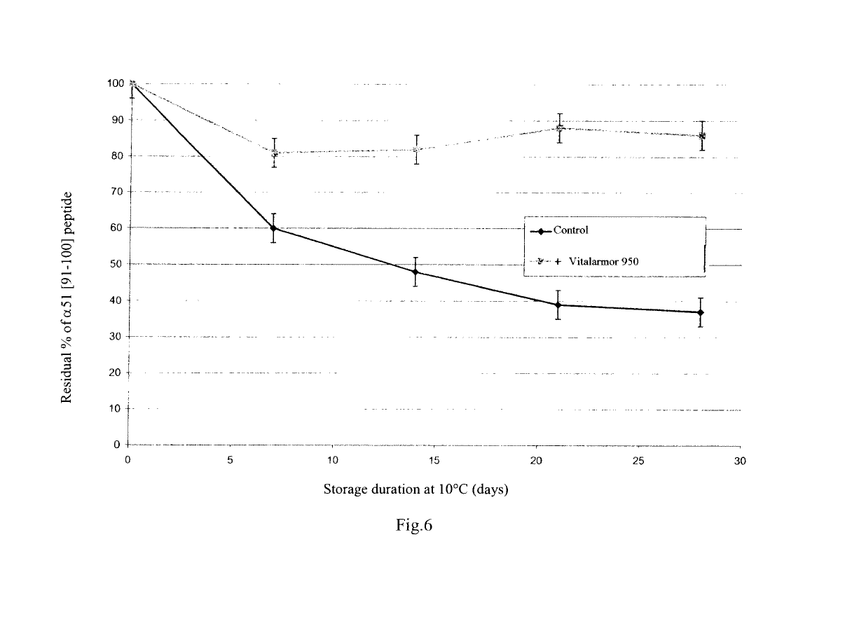

FIG. 6: Illustration of the evolution of the residual content in bioactive αS1 [91-100] peptide in a final product comprised of 95% mass fermented by the ferment containing the I-2774 strain and formate and 5% flavored sugar syrup containing the αS1 [91-100] peptide (supplied in the form of Lactium® in an amount of 1.5 g/kg of final product), during storage at 10° C. until the UBD.

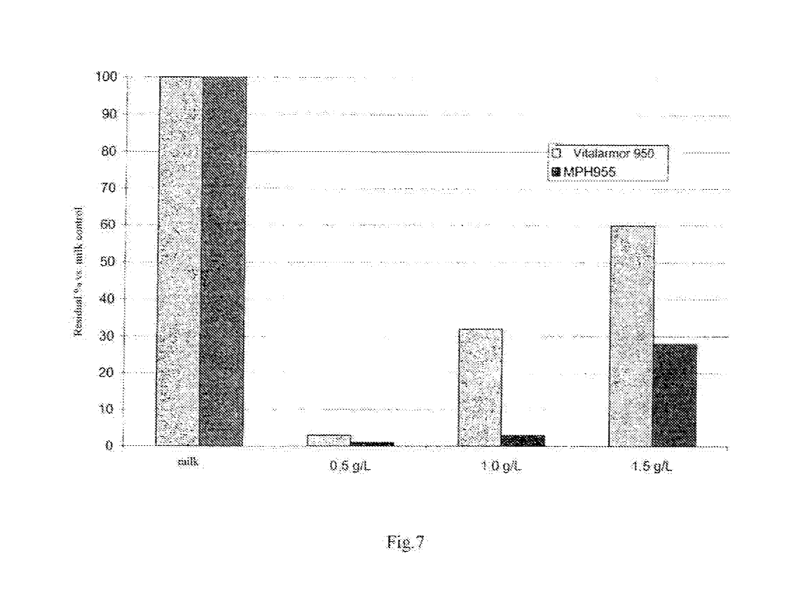

FIG. 7: Graph illustrating the percentage of residual αS1 [91-100] peptide after fermentation compared to the unfermented control (ferment containing strains I-2783, I-2774, I-2835 and I-1968) in the presence of increasing concentrations (0.5, 1.0 and 1.5 g/l) of “decoy” hydrolysates (Vitalarmor 950, Armor Proteines; MPH 955, Fonterra).

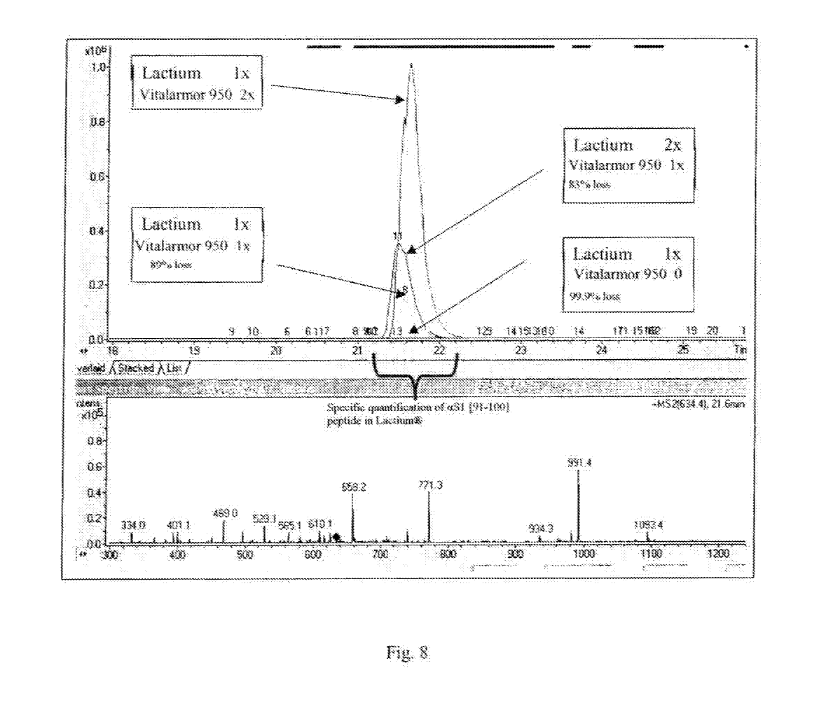

FIG. 8: Quantification of the residual quantity of αS1 [91-100] peptide after fermentation by the ferment containing strains I-2783, I-2774, I-2835 and I-1968 in a milk medium, as a function of the initial quantity of the ingredient of interest (Lactium®, 1X=1.5 g/l) and the decoy ingredient (Vitalarmor 950 hydrolysate, 1X=1.5 g/l).

Other characteristics and advantages of the present invention will become apparent upon reading the following examples, which are given for purposes of illustration only.

### EXAMPLES

### Example 1

### Use of Bioactive Ingredients of Interest without Application of the Claimed Invention

1.1) Example with the Bioactive αS1 [91-100] Peptide contained in the Lactium® Hydrolysate

The use of peptide or protein ingredients, often supplied in the form of powders, is simpler when said ingredients are added when the dairy “mix” is prepared (powdering of the milk), before the sanitary heat treatment (i.e., 95° C., 8 min) and, therefore, before fermentation. In this case, the risk of metabolism of the active peptide is very high. This is the case, for example, during the use of a functional product such as Lactium® (Ingredia, France) containing a bioactive peptide (fragment 91-100 of aS1-casein).

Protocol

The medium was prepared by hydration of powdered skim milk to 120 g/l, supplemented with 1.5 g/l of Lactium® (corresponding to approximately 30 mg/l of the bioactive αS1 [91-100] peptide), then pasteurized at 95° C. for 8 minutes.

The lactic ferment was added in a proportion of 0.02% and fermentation was carried out at the optimal temperature for the selected ferment (37-42° C.) until a pH of 4.70 was reached.

The analysis of residual peptides, notably that of the bioactive αS1 [91-100] peptide, was carried out using high-performance liquid chromatography (HPLC) coupled with an MS/MS detector as follows:
The sample was prepared by dilution of the fermented medium in a mixture of water, methanol and trifluoroacetic acid (50/50/0.1%) in a ratio of approximately 1:6. After centrifugation, the supernatant constituted the representative sample of the peptide content of the fermented medium.
Said sample was injected into an Agilent 1100 HPLC system (Agilent Technologies France, 1 rue Galvani, 91745 Massy Cedex, France), equipped with a Waters Symetry® column suitable for peptide analysis (5 μm, 2.1×150 mm, WAT056975, Waters France, 5, rue Jacques Monod, 78280 Guyancourt) at a temperature of 40° C. and a flow rate of 0.25 ml/min. The peptides were eluted in a conventional way with an increasing gradient of solvent B (acetonitrile and 0.100% formic acid) in solvent A (water and 0.106% formic acid) for a period of 40 minutes to 2 hours as a function of the resolution desired.
Detection was carried out using a specific MS/MS detector, for example with an ionic trap device such as the Esquire 3000+(Bruker Daltonique, rue de l'Industrie, 67166 Wissembourg Cedex) set either for overall analysis of peptide content (MS-MS mode) or for the precise and specific quantification of a peptide from its characteristic fragments. For example, the αS1 [91-100] peptide was isolated from its mass (doubly charged ion of mass 634.5 Da) and quantified from the intensity of its characteristic daughter ions after fragmentation (ions for m/z=991.5 Da, 771.5 Da and 658.3 Da). In an even more precise manner, an internal standard comprised of the same doubly deuterated synthetic peptide (993.5 Da characteristic fragment) made it possible to take into account and to exclude potential interference related to the matrix.

Results are illustrated in FIG. 1.

At this stage of its use (before fermentation by a ferment consisting of a mixture of the strains I-2783 (deposited with the CNCM on Jan. 24, 2002), I-2774 (deposited with the CNCM on Jan. 24, 2002), I-2835 (deposited with the CNCM on Apr. 4, 2002) and I-1968 (deposited with the CNCM on Jan. 14, 1998), or a ferment such as YC-380 (Chr. Hansen S A, Le Moulin d'Aulnay, BP64, 91292 ARPAJON Cedex France), it was demonstrated that more than 95% of the bioactive α_{S1 [}91-100] peptide was consumed after fermentation.

These observations show that the incorporation of bioactive peptides according to the example above is not applicable to obtaining food products, notably dairy products, supplemented with quantities of peptides and/or bioactive proteins that are sufficiently stable over time to observe the effect sought in the consumer.

1.2) Examples with Other Bioactive Peptides of Interest

Results are illustrated in FIGS. 2 and 3.

Lactium® contains many other peptides, some of which exhibit potential biological activity (such as α_{S1}-casein fragment 23-34, also sold as C12® by DMV International). It is interesting to note that virtually all of the peptides provided by the addition of Lactium® are consumed during fermentation.

Regardless of their origin (arising from the various αS1-, αS2-, κ- and β-caseins) and of their size (from 2 to 3 residues up to 12 residues and more), all of the peptides are completely consumed during the fermentation process.

1.3) Use of the Bioactive α_{S1 [}91-100] Peptide (Lactium®) with Other Ferments

In order to verify that this phenomenon was not specific to the two ferments used in paragraph 1.1) above, the principle industrial ferments, as well as various pure strains used in the composition of said ferments, were examined using the same test: milk reconstituted from powdered milk, to which Lactium® was added in an amount of 1.5 g/l, was fermented under standard conditions (optimal temperature for the ferment between 37° C. and 42° C., fermentation stopped at pH 4.7, two repetitions). Analysis of the level of bioactive αS1 [91-100] peptide was then carried out on the sample before and after fermentation.

The results obtained for the pure strains are presented in table 3 below:

TABLE 3

| | % of αS1 [91-100] peptide |
|---|---|
| | remaining after fermentation |
| Pure strains | |
| (S. thermophilus) | |
| I-1630 (Oct. 24, 1995) | 0.3 |
| I-1477 (Sept. 22, 1994) | 0.3 |
| Pure strains (Lactobacillus) | |
| I-1632 (Oct. 24, 1995) | 0.2 |
| I-1519 (Dec. 30, 1994) | 0.1 |
| I-1968 (Jan. 14, 1998) | 1.6 |
| I-2809 (Feb. 19, 2002) | 0.4 |

In table 3 above, which reflects the consumption of the bioactive αS1 [91-100] peptide by various ferments and industrial strains during the fermentation of a dairy mix containing 1.5 g/l of Lactium®, the pure strains were identified by their CNCM (Pasteur Institute, Paris, France) number and deposit date.

Table 3 shows that the all of the enzymes and strains tested metabolize from 94% to 100% of the bioactive αS1 [91-100] peptide during the fermentation of a standard dairy mix. The use of this product is therefore impossible under conventional conditions to produce food products, notably dairy products, containing peptides and/or bioactive proteins in quantities that are sufficiently stable over time to produce an effect in the consumer.

In addition, in order to verify that this phenomenon was not specific to Lactium®, several combinations of ferments and other ingredients containing bioactive peptides were studied by implementing the same test (reconstituted milk and an ingredient to be tested in an amount of 1.5 g/l, fermented under standard conditions, fermentation stopped at pH 4.7, two repetitions). The various combinations tested are presented in table 4 below.

TABLE 4

| | aS1 [91-100] | Other | | |
|---|---|---|---|---|
| | Peptide in | peptides in | DMV | DMV |
| Enzymes/pure strains | Lactium ® | Lactium ® | C12 ® | CPP ® |
| Mix of 4 strains: | | | | |
| I-2783 (Jan. 24, 2002) | X | X | X | X |
| I-2774 (Jan. 24, 2002) | | | | |
| I-2835 (Apr. 4, 2002) | | | | |
| I-1968 (Jan. 14, 1998) | | | | |
| I-1630 (Oct. 24, 1995) | X | | X | X |
| Hansen YC-380 | X | X | X | X |

The ingredients C12® and CPP® produced by DMV International are milk protein hydrolysates containing bioactive peptides targeting the control of hypertension and the assimilation of minerals, respectively.

Across all of the experiments, it is apparent that all of the ferments tested have a significant capacity to metabolize peptides, regardless of the nature and size thereof.

1.4) Addition after Fermentation

A logical alternative to the procedure studied above is to introduce the functional ingredient after fermentation (“delayed differentiation” procedure), for example with the syrup used to flavor the fermented mass. The use of the same quantity of Lactium® according to this protocol led to the results presented in FIG. 4.

As shown in FIG. 4, even added cold (4° C.) after fermentation, the active peptide (supplied by the equivalent of 1.5 g of Lactium® per kg of final product) is quickly degraded during storage, leaving only 30-40% of the initial quantity on the use-by date (UBD).

Thus, the population of living lactic bacteria in the final product continues to metabolize the bioactive peptide during storage of the final product, so that after only 10 days (for fresh products whose UBD is 28 days), 35-50% of the αS1 [91-100] peptide has disappeared, a fact which remains unacceptable for obtaining the required effect in the consumer.

1.5) Heat Treatment of the Fermented Dairy Product Containing the Bioactive Ingredient of Interest

In this case, it is possible to assure the stability of the αS1 [91-100] peptide (FIG. 5), but to the detriment of the overall quality of the final product. This solution indeed presents many disadvantages:
the thermization of a fermented dairy mass involves the use of stabilizers added before the heat treatment (pectins, starches, carrageenans, etc.), thus complicating the process and significantly increasing the cost of the formula;
the industrial production line is more complex and requires a more significant specific investment;
the product will no longer benefit from designations related to products containing living ferments (yogurts) and in fact will lose the benefits associated with the consumption of lactic ferments; and
the organoleptic impact (generally negative) is significant.

### Example 2

### Use of Bioactive Ingredients of Interest while Applying the Claimed Invention

The strategy consists of saturating the proteolytic and peptide transport systems of lactic bacteria by adding a sufficient quantity of one or more peptides (“decoy” peptides) that are more preferred compared to the peptide(s) which are sought to be protected. The protective effect exists both during fermentation and during storage of the final product until the UBD. FIG. 6 presents an example based on the model of the preceding tests.

As shown in FIG. 6, the αS1 [91-100] peptide supplied in the form of Lactium® after fermentation is largely protected in the presence of the Vitalarmor 950 casein hydrolysate (Armor Proteins, France) compared to the control.

The choice of the nature and quantity of the decoy peptide to be used to achieve sufficiently effective protection is significant. Thus, many commercial hydrolysates (primarily enzymatic hydrolysates of bovine milk proteins) were tested and evaluated, as summarized in table 5 below.

Table 5 shows the consumption of the bioactive αS1 [91-100] peptide (supplied by the equivalent of 1.5 g/l of Lactium®) during fermentation by the ferment containing the strains I-2783, I-2774, I-2835 and I-1968, in the presence of various commercial hydrolysates (identical concentration of 1.5 g/l).

TABLE 5

| Decoy hydrolysate (brand name) | % [91-100] after fermentation |
|---|---|
| MPH 955 | 28.0 |
| Alaco 70-14 | 33.8 |
| WPH 917 | 1.7 |
| WPH 955 | 56.6 |
| Arla 20-21 | 6.2 |
| WPH 926 | 29.1 |
| DSE 6441 | 23.6 |
| WPH 948 | 12.8 |
| Biozate 1 | 3.0 |
| MPH 910 | 0.4 |
| DSE 6060 | 0.5 |
| Alatal 821 | 46.0 |
| Vitalarmor 950 | 55.5 |
| DMV C12 | 33.5 |

MPH 955: casein protein hydrolysate, NZMP GmbH, Siemensstrasse 6-14, D-25462, Rellingen, Germany
Alaco 70-14: whey protein hydrolysate, NZMP GmbH, Siemensstrasse 6-14, D-25462, Rellingen, Germany
WPH 917: whey protein hydrolysate, NZMP GmbH, Siemensstrasse 6-14, D-25462, Rellingen, Germany
WPH 955: whey protein hydrolysate, NZMP GmbH, Siemensstrasse 6-14, D-25462, Rellingen, Germany
Arla 20-21: whey protein hydrolysate, Arla Foods Amba Ingredients, 2 rue Victor Griffuelhes, 92772 Boulogne Cedex, France
WPH 926: whey protein hydrolysate, NZMP GmbH, Siemensstrasse 6-14, D-25462, Rellingen, Germany
DSE 6441: whey protein hydrolysate, NZMP GmbH, Siemensstrasse 6-14, D-25462, Rellingen, Germany
WPH 948: whey protein hydrolysate, NZMP GmbH, Siemensstrasse 6-14, D-25462, Rellingen, Germany
Biozate 1: whey protein hydrolysate, Davisco Foods International, 11000 West 78^{th} Street, Suite 210, Eden Prairie, Minn. USA 55344
MPH 910: casein protein hydrolysate, NZMP GmbH, Siemensstrasse 6-14, D-25462, Rellingen, Germany
DSE 6060: whey protein hydrolysate, NZMP GmbH, Siemensstrasse 6-14, D-25462, Rellingen, Germany
Alatal 821: whey protein hydrolysate, NZMP GmbH, Siemensstrasse 6-14, D-25462, Rellingen, Germany
Vitalarmor 950: casein hydrolysate, Armor Proteins, 35460 Saint Brice en Cogles, France
DMV C12: dairy protein hydrolysate, DMV International, P.O. Box 105, Redhill Surrey RH1 3YH, United Kingdom

According to table 5, certain hydrolysates have only little or no effect (only several percent of the (S1 [91-100] peptide remains after fermentation, even in their presence). On the other hand, others have a good protective effect since up to more than 50% of the αS1 [91-100] peptide is found after fermentation.

The concentration of the decoy peptide is also a significant factor: the higher said concentration, the stronger the protection of the peptide of interest, as shown in FIG. 7.

Overall, it is the ratio of peptide of interest to decoy peptide that controls whether the protective effect is more or less effective for the peptide of interest, as shown in FIG. 8.

The protection thus obtained is not specific to the αS1 [91-100] peptide, but relates to the majority of the peptide hydrolysates of interest.

Thus it is possible to protect, via a judicious choice of a decoy ingredient supplied in sufficient quantity, any type of peptide in a broad range of sizes.

### REFERENCES

Kayser et al., (1996) FEBS Letters 383, 18-20
Hata Y. et al., (1996) Am. J. Clin. Nutr. 64, 767-71
Nakamura Y. et al., (1995) J. Dairy Sci. 78, 1253-7
Migliore-Samour D. et al., (1988) Experimentia 44, 188-93
Defilippi C. et al., (1995) Nutr. 11, 751-4
Tomé D. et al., (1987) Am. J. Physiol. 253, G737-44
Tomé D. et al., (1988) Reprod. Nutri. Develop. 28, 909-18
Ben Mansour A. et al., (1988) Pediatr. Res. 24, 751-5
Mahé S. et al., (1989) Reprod. Nutri. Dévelop. 29, 725-32
Schusdziarra V. et al., (1983) Diabetologia 24, 113-6
Yvon M. et al., (1994) Reprod. Nutri. Develop. 34, 527-37
Zucht H. D. et al., (1995) FEBS Letters 372, 185-8
Tomita M. et al., (1994) Acta Paed. Jap. 36, 585-91
Lahov E. et al., (1996) Food Chem. Toxic. 34, 131-145
Migliore-Samour D. et al., (1989) Int. Dairy Res. 56, 357-62
Jollès P. et al., (1986) Europ. J. Biochem. 158, 379-82
Raha S. et al., (1988) Blood 772, 172-8
Chabance B. et al., (1995) Brit. J. Nut. 73, 582-90
Kohmura M. et al., (1989) Agric. Biol. Chem. 53, 2107-14
Masuda O. et al., (1996) J. Nutr. 126, 3063-8
Yamamoto N. et al., (1994) Biosci. Biotech. Biochem. 58, 776-8
Ermisch A. et al., (1983) J. Neurochem. 41, 1229
Umbach M. et al., (1985) Regul. Pept. 12, 223-30
Singh M. et al., (1989) Pediatr. Res. 26, 34-8
Svedberg J. et al., (1985) Peptides 6, 825-30
Teschemacher H. et al., (1986) J. Dairy Res. 53, 135-8
Yoshikawa M. et al., (1986) Agric. Biol. Chem. 50, 2419-21
Chiba H. et al., (1989) J. Dairy Sci. 72, 363
Beucher S. et al., (1994) J. Nutr. Biochem. 5, 578-84
Parker F. et al., (1984) Eur. J. Biochem. 45, 677-82
Otani H. et al., (1992) Milchwiss. 47, 512-5
Otani H. et al., (1995) J. Dairy Res. 62, 339-48
Drouet et al., (1990) Nouv. Rev. Fr. Hermatol. 32, 59-62
Mullaly M. et al., (1997) Int. Dairy J. 7, 299-303
Meisel H. et al., (1986) FEBS Letters 196, 223-7
Garault et al., (2002) J. Biol. Chem. 277: 32-39
Danone World Newsletter No. 17 (September 1998)
Functional Food Science in Europe (1998) British Journal of Nutrition 80(1):S1-S193

1. A food product containing one or more living microorganisms and at least one bioactive food ingredient of interest, wherein said bioactive food ingredient(s) of interest are protected by means of at least one decoy food ingredient contained in said food product, in such a way that the metabolism of said bioactive food ingredient(s) of interest by said living microorganism(s) is reduced.

2. The food product according to claim 1, wherein the residual quantity of bioactive food ingredient(s) of interest in said food product is, three weeks after the preparation thereof, approximately 50-100% compared to the quantity of bioactive food ingredient(s) of interest present in the product immediately following the preparation thereof.

3. The food product according to claim 2, wherein said residual quantity is approximately 80-100% compared to said quantity of bioactive food ingredient(s) of interest present in the product immediately following the preparation thereof.

4. A The food product according to claim 1, wherein said food product contains between approximately 0.001% and 2% by weight of decoy food ingredient(s) compared to the total weight of the final product.

5. The food product according to claim 4, wherein said food product contains between approximately 0.001% and 0.2% by weight of decoy food ingredient(s) compared to the total weight of the final product.

6. The food product according to claim 1, wherein the rate of metabolism of the decoy food ingredient(s) in said food product is, three weeks following the preparation thereof, at least equal to that of the bioactive food ingredient(s) of interest.

7. The food product according to claim 1, wherein said bioactive food ingredient(s) of interest and/or said decoy food ingredient(s) are selected from the group consisting of:
proteins,
peptides,
analogs and derivatives thereof, and
combinations thereof.

8. The food product according to claim 7, wherein said bioactive food ingredient(s) of interest are selected from the group consisting of: αS1 [91-100] peptide, C6-α_{S1 [}194-199] peptide, C7-β177-183 peptide, C12-α_{S1 [}23-34] peptide, casein phosphopeptides, α-casomorphin, α-casein exorphin, casokinin, β-casomorphin, casein macropeptides and glycomacropeptides, casoxin, casoplatellins, fragments 50-53, β-lactorphins, lactoferroxin, Val-Pro-Pro peptides, Lys-Val-Leu-Pro-Val-Pro-Gln peptides, Tyr-Lys-Val-Pro-Gln-Leu peptides, Tyr-Pro peptides, Ile-Pro-Pro peptides, fragments, analogs and derivatives thereof, proteins and/or peptides comprised thereof and combinations thereof.

9. The food product according to claim 8, wherein said bioactive food ingredient(s) of interest are selected from the group consisting of: αS1 [91-100] peptide, fragments, analogs and derivatives thereof, proteins and/or peptides comprised thereof and combinations thereof.

10. The food product according to claim 7, wherein said decoy food ingredient(s) are a nutritional source of nitrogen for said living microorganism(s).

11. The food product according to claim 10, wherein said decoy food ingredients are selected from the group consisting of:
Alatal® 821;
Vitalarmor 950;
fragments, analogs and derivatives thereof;
proteins and/or peptides comprised thereof; and
combinations thereof.

12. The food product according to claim 1, wherein said living microorganism(s) have an intact or reduced capacity to metabolize said bioactive food ingredient(s) of interest.

13. The food product according to claim 1, wherein said living microorganism(s) are living bacteria, preferably living lactic bacteria.

14. The food product according to claim 13, wherein said living bacteria are selected from the group consisting of:
Streptococcus spp., preferably Streptococcus thermophilus;
Lactobacillus spp.;
Lactococcus spp.; and
Bifidobacterium spp.

15. The food product according to claim 14, wherein said food product contains at least the living bacteria S. thermophilus and Lactobacillus spp.

16. The food product according to claim 14, wherein said living S. thermophilus bacteria are selected from the group consisting of:
Streptococcus thermophilus, deposited with the CNCM on Jan. 24, 2002, number I-2774;
Streptococcus thermophilus, deposited with the CNCM on Oct. 24, 1995, number I-1630;
Streptococcus thermophilus, deposited with the CNCM on May 10, 2004, number I-3211;
Streptococcus thermophilus, deposited with the CNCM on Sep. 16, 2004, number I-3301; and
Streptococcus thermophilus, deposited with the CNCM on Sep. 16, 2004, number 1-3302.

17. The food product according to claim 16, wherein said living bacteria are S. thermophilus bacteria deposited with the CNCM on May 10, 2004, number I-3211.

18. The food product according to claim 1, wherein said food product is a fermented product.

19. The food product according to claim 18, wherein said food product is a dairy product or a plant product.

20. A method for preparing a food product according to claim 1, wherein said decoy food ingredient(s) are added to the mixture constituting said food product after the fermentation thereof.

21. A method for preparing a food product according to claim 1, wherein said living microorganism(s) and/or said bioactive food ingredient(s) of interest and/or said decoy food ingredient(s) are added sequentially to the mixture constituting said food product.

22. A method for preparing a food product according to claim 1, wherein said living microorganism(s) and/or said bioactive food ingredient(s) of interest and/or said decoy food ingredient(s) are added simultaneously to the mixture constituting said food product.

23. A method for preparing a food product according to claim 1, wherein said bioactive food ingredient(s) of interest and/or said decoy food ingredient(s) are prepared directly in the mixture constituting said food product.

24. The method for preparing a food product according to claim 23, wherein said living microorganism(s) are added to the mixture constituting said food product before the in situ synthesis of said bioactive food ingredient(s) of interest and/or of said decoy food ingredient(s).

25. The method for preparing a food product according to claim 23, wherein said living microorganism(s) are added to the mixture constituting said food product during the in situ synthesis of said bioactive food ingredient(s) of interest and/or of said decoy food ingredient(s).

26. The method for preparing a food product according to claim 23, wherein said living microorganism(s) are added to the mixture constituting said food product after the in situ synthesis of said bioactive food ingredient(s) of interest and/or of said decoy food ingredient(s).

27. (canceled)

28. (canceled)

29. The food product according to claim 1, wherein said food product is a functional food.

30. A method for protecting at least one bioactive food ingredient of interest in a food product containing one or more living microorganisms, comprising the use of at least one decoy food ingredient as an agent protecting said bioactive food ingredient(s) of interest against metabolism by said living microorganism(s).
